(19) United States
(12) Patent Application Publication
(10) Pub. No.: US 2010/0045168 A1
(43) Pub. Date: Feb. 25, 2010

(54) WHITE LIGHT LIGHT-EMITTING DIODES

(75) Inventors: Jung-Chieh Su, Taipei City (TW); Sian-Wei CHEN, Taipei City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY OF SCIENCE & TECHNOLOGY, Taipei City (TW)

(21) Appl. No.: 12/325,072

(22) Filed: Nov. 28, 2008

(30) Foreign Application Priority Data
Aug. 22, 2008 (TW) TW97132062

(51) Int. Cl. H01J 1/62

(52) U.S. Cl. 313/503

(57) ABSTRACT

A white light light-emitting diode is provided. The white light light-emitting diode includes a substrate including an anode and a cathode or a circuit, an ultraviolet light-emitting diode emitting ultraviolet with a peak wavelength between 320-400 nm disposed on the substrate, and a phosphor layer formed by blending blue, yellow and red phosphor grains with transparent resin pervious to ultraviolet and visible light applied on the ultraviolet light-emitting diode, wherein the yellow phosphor grains are excited by blue light with an emission band between about 400-530 nm.

### BACKGROUND OF THE INVENTION

1. Field of the Invention

The invention relates to a white light light-emitting diode, and in particular to a white light light-emitting diode with a layer comprising blue, yellow and red phosphor grains.

2. Description of the Related Art

A white light light-emitting diode (LED) is a point light source and packaged into matrix LED for illumination. When combined with different color LEDs, variety of mixing color light can be achieved.

Combining at least two chromatic lights with various wavelengths produces white light. For example, combining blue and yellow light or blue, green and red light. Because light sources closer to sunlight are desirable, a white light LED with a specific spectrum, color rendering and correlated color temperature (CCT) similar to sunlight has been developed. The color rendering index (CRI) represents a real color exhibition of a subject while a light source irradiate thereon, which is compared to sunlight. Additionally, illumination demands for the home and factory are different. In the home, warm white source with low color temperature is required, for example, similar to the color of conventional tungsten-filament bulb. To the contrary, an illumination with high color temperature is required in the factory. Additionally, for LCD panels, a sufficient gamut of backlight (a light source) is required. Thus, various light sources have various illumination demands, and are designed to meet those demands.

White light LEDs comprise of organic LEDs and inorganic LEDs. There are three main methods of forming the white light source of the inorganic LED. One is by a white light LED module composed of red, blue and green LEDs, with high luminous efficiency and high color rendering. However, various epitaxial materials (red, blue and green LED) exhibit different voltage properties, resulting in high cost and complicated control circuit design for implementation. Also, mixing trichromatic light to form white light is difficult. The second method uses blue LED to excite yellow phosphor grains to produce white light (Nichia Corporation). The blue LED is covered by an optical resin mixed with yellow phosphor grains. The blue LED emits blue light with a wavelength of 400-530 nm. The yellow phosphor grains are excited by the blue light emitted from the blue LED to produce yellow light, and combined with a proper amount of emitted blue light to finally produce the white light.

However, the white light LED using the blue LED to excite the yellow phosphor grains suffers from some drawbacks. First, high color temperature and non-uniform light source are generated since the blue light dominated in the emitting spectrum. Also, an increasing in interaction between the blue light and the yellow phosphor grains is required to reduce the blue light intensity or increase yellow light intensity. However, the wavelength of blue light is shifted with increasing temperature, resulting in color shift of the white light emission. Finally, red light intensity is lacked, resulting in insufficient color rendering. Although red phosphor grains can be added to improve color rendering, color shift issue exist eventually.

Another method uses ultraviolet LED to excite blue, green and red phosphor grains mixed in a transparent optical resin with a specific ratio, similar to white light generated from the fluorescent lamps. The white light source is uniform and high color rendering, without color shift. However, the luminous efficiency thereof is low. For example, Y. Narukawa utilizes 400 nm ultraviolet to excite blue and yellow phosphor grains under 20 mA to form a white light with color temperature of 5800K and color rendering index of 85.3. T. Nishida utilizes 350 nm ultraviolet to excite red, blue and green phosphor grains to form a white light with color rendering index of 86 and CIE color coordinates (x, y) of (0.411-0.416, 0.397-0.401). In order to improve color rendering, S. Nayama utilizes 375-380 nm ultraviolet to excite red, blue, green and yellow phosphor grains to form a white light with color rendering index of 94.2 and color temperature of 5800K. Y. Narukawa utilizes ultraviolet to excite blue-green, yellow and red phosphor grains under 20 mA to form a white light with color rendering index of 97 and color temperature of 5000K. The color shift, which results in using ultraviolet to excite various phosphor grains, is smaller than that of using blue light to excite yellow phosphor grains under 5 mA to 60 mA. U.S. Pat. No. 6,685,852 disclosed using 315-480 nm light sources to excite seven phosphor grains to form white light. Although the color rendering thereof achieved 95, at least four phosphor grains were required. US 2006/0022582 disclosed using 250-500 nm near ultraviolet or visible light to excite at least three phosphor grains, for example, green, orange and red phosphor grains to form white light. Light sources with high color rendering can be achieved by adjusting the concentration of the phosphor grains. However, its color was warm white. US 2007/0235751 disclosed using 405 nm ultraviolet to excite five phosphor grains to form a white light with color rendering index of 97.4. US 2007/0221938 disclosed using 400-405 nm light sources to excite red, yellow and blue or green or blue-green phosphor grains to form white light. Warm-white light sources with color rendering index of 90-99 can be achieved by adjusting the weight ratios among the phosphor grains.

### BRIEF SUMMARY OF THE INVENTION

One embodiment of the invention provides a white light light-emitting diode comprising a substrate comprising an anode and a cathode or a circuit, an ultraviolet light-emitting diode with a peak wavelength between 320-400 nm disposed on the substrate, and a phosphor layer formed by blending blue, yellow and red phosphor grains with optically transparent resin, wherein the yellow phosphor grains are excited by blue light with wavelength of 400-530 nm. The phosphor layer is applied onto the ultraviolet light-emitting diode.

Another embodiment of the invention provides a white light light-emitting diode comprising a substrate comprising an anode and a cathode or a circuit, an ultraviolet light-emitting diode emitting ultraviolet with a peak wavelength between 320-400 nm disposed on the substrate, a transparent resin layer pervious to ultraviolet and visible light overlying the ultraviolet light-emitting diode, and a phosphor layer formed by blending blue, yellow and red phosphor grains with transparent resin, wherein the yellow phosphor grains are excited by blue light with wavelength of 400-530 nm. The phosphor layer is applied onto the transparent resin layer.

Yet another embodiment of the invention provides a white light light-emitting diode comprising a substrate comprising an anode and a cathode or a circuit, an ultraviolet light-emitting diode emitting ultraviolet with a peak wavelength between 320-400 nm disposed on the substrate, a transparent layer pervious to ultraviolet and visible light overlying the ultraviolet light-emitting diode, and a plurality of phosphor layers comprising blue, yellow and red phosphor layers respectively formed by blending blue, yellow or red phosphor grains with optical resin, wherein the yellow phosphor grains are excited by blue light with wavelength of 400-530 nm.

In the invention, the blue, yellow and red phosphor grains are excited and their emitting lights are mixed to form white light. The red and blue phosphor grains are first excited by the ultraviolet light-emitting diode with a wavelength of 320-400 nm to emit red and blue light. The yellow phosphor grains are then excited by the emitting blue light to emit yellow light. The yellow light is formed through secondary excitation, rather than primary excitation. The remaining blue light is then combined with the yellow and red light to form white light with color rendering exceeding 90.

In the white light light-emitting diode, the blue, yellow and red phosphor grains mixed in the phosphor layer with a proper ratio are excited by the ultraviolet light-emitting diode, achieving CIE color coordinates of (0.33, 0.33), color temperature of 3000-8000K and color rendering exceeding 90.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIG. 1 is a cross-sectional view of a white light light-emitting diode in an embodiment of the invention.

FIG. 2 is a cross-sectional view of a white light light-emitting diode in an embodiment of the invention.

FIG. 3 is a cross-sectional view of a white light light-emitting diode in an embodiment of the invention.

FIG. 4 is a spectrum of a white light light-emitting diode in an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

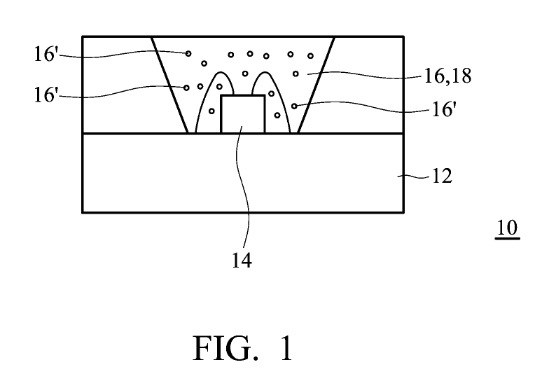

An embodiment of a white light light-emitting diode of the invention is shown in FIG. 1. The white light light-emitting diode 10 comprises a substrate 12, an ultraviolet light-emitting diode 14 and a phosphor layer 16. The substrate 12 comprises an anode and a cathode (not shown) or a circuit (not shown). The ultraviolet light-emitting diode 14 is disposed on the substrate 12. The phosphor layer 16 is applied on the ultraviolet light-emitting diode 14. The phosphor layer 16 comprises blue, yellow and red phosphor grains 16′ and a transparent resin 18. The yellow phosphor grains may comprise one of YAG, TAG and BOS phosphor grains.

The ultraviolet light-emitting diode 14 may comprise Ill-V photosemiconductor, for example, GaN, InGaAlN or AlGaN. The ultraviolet light-emitting diode 14 emitted ultraviolet with a wavelength of 320-400 nm to excite the blue and red phosphor grains in the phosphor layer 16 to emit blue and red light. The yellow phosphor grains are excited by blue light with a wavelength of about 400-530 nm emitted from the blue phosphor grains to emit yellow light. The remaining blue light is then combined with the yellow and red light to form white light.

In the phosphor layer 16, the blue phosphor grains have a weight percent of about 15-50%. The yellow phosphor grains have a weight percent of about 10-70%. The red phosphor grains has a weight percent of about 15-40%. The transparent resin 18 is pervious to ultraviolet and visible light. The transparent resin 18 may comprise epoxy or silicon resin. The white light light-emitting diode 10 is a surface mount device (SMD) type white light light-emitting diode.

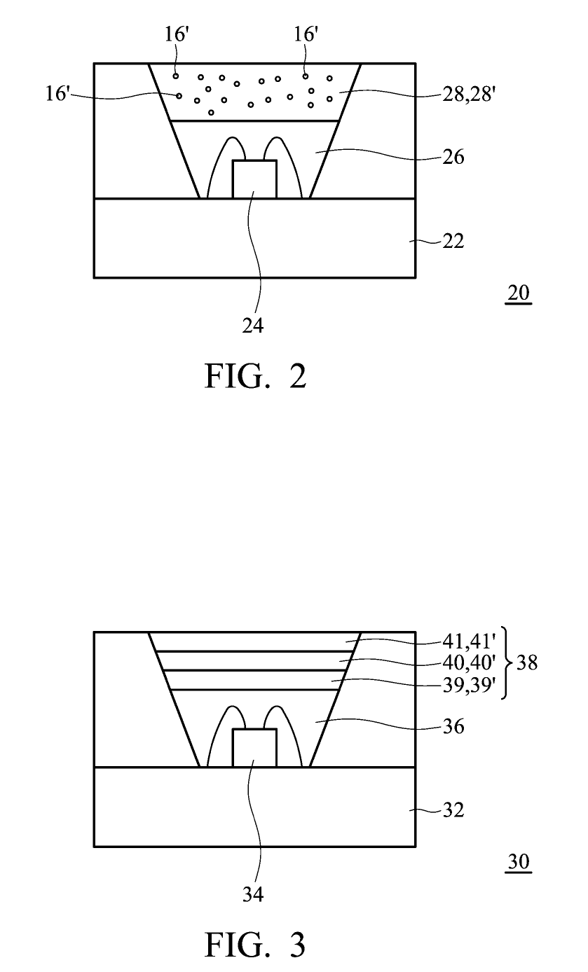

Another embodiment of a white light light-emitting diode of the invention is shown in FIG. 2. The white light light-emitting diode 20 comprises a substrate 22, an ultraviolet light-emitting diode 24, a transparent layer 26 and a phosphor layer 28. The substrate 22 comprises an anode and a cathode (not shown) or a circuit (not shown). The ultraviolet light-emitting diode 24 is disposed on the substrate 22. The transparent layer 26 overlies the ultraviolet light-emitting diode 24. The phosphor layer 28 is applied on the transparent layer 26. The phosphor layer 28 comprises blue, yellow and red phosphor grains 16′ and a transparent resin 28′. The yellow phosphor grains may comprise one of the YAG, TAG and BOS phosphor grains.

The ultraviolet light-emitting diode 24 may comprise Ill-V photosemiconductor, for example, GaN, InGaAlN or AlGaN. The ultraviolet light-emitting diode 24 may emit ultraviolet with a wavelength of 320-400 nm to excite the blue and red phosphor grains in the phosphor layer 28 to emit blue and red light. The yellow phosphor grains are excited by the emitting blue light from the blue phosphor grains to emit yellow light. The remaining blue light is then combined with the yellow and red light to form white light. The transparent layer 26 may be pervious to ultraviolet and visible light and comprise epoxy or silicon resin.

In the phosphor layer 28, the blue phosphor grains have a weight percent of about 15-50%. The yellow phosphor grains have a weight percent of about 10-70%. The red phosphor grains have a weight percent of about 15-40%. The transparent resin 28′ may be pervious to ultraviolet and visible light and comprise epoxy or silicon resin.

Yet another embodiment of a white light light-emitting diode of the invention is shown in FIG. 3. The white light light-emitting diode 30 comprises a substrate 32, an ultraviolet light-emitting diode 34, a transparent layer 36 and a plurality of phosphor layers 38. The substrate 32 comprises an anode and a cathode (not shown) or a circuit (not shown). The ultraviolet light-emitting diode 34 is disposed on the substrate 32. The transparent layer 36 overlies the ultraviolet light-emitting diode 34. The phosphor layers 38 were applied on the transparent layer 36. The phosphor layers 38 comprises a blue phosphor layer 39, a yellow phosphor layer 40, a red phosphor layer 41 with transparent resin 39′, 40′ and 41′ dispersed in each phosphor layer. The blue phosphor grains have a weight percent of about 5-40% in the blue phosphor layer 39. The yellow phosphor grains have a weight percent of about 10-50% in the yellow phosphor layer 40. The red phosphor grains have a weight percent of about 5-40% in the red phosphor layer 41. The transparent resin 39′, 40′ and 41′ may be pervious to ultraviolet and visible light and comprise epoxy or silicon resin.

In this embodiment, the phosphor layers 48 comprise the blue phosphor layer 39, the yellow phosphor layer 40 and the red phosphor layer 41 from bottom to top. However, the invention is not limited thereto, as any combination of the phosphor layers may be appropriate. However, the blue phosphor layer underlying the yellow phosphor layer is required to excite yellow phosphor grains. The yellow phosphor grains may comprise YAG, TAG or BOS phosphor grains.

The ultraviolet light-emitting diode 34 may comprise GaN, InGaAlN or AlGaN. The ultraviolet light-emitting diode 34 may emit ultraviolet with a wavelength of 320-400 nm to excite the blue and red phosphor grains in the phosphor layers 38 to emit blue and red light. The yellow phosphor grains are excited by the emitting blue light from the blue phosphor grains to emit yellow light. The remaining blue light is then combined with the yellow and red light to form white light. The transparent layer 36 may be pervious to ultraviolet and visible light and comprise epoxy or silicon resin.

In the invention, the blue, yellow and red phosphor grains are excited and their emitting lights are mixed to form white light. The red and blue phosphor grains are first excited by the ultraviolet light-emitting diode emitting ultraviolet with a wavelength of 320-400 nm to emit red and blue light. The yellow phosphor grains are then excited by the emitting blue light to emit yellow light. The yellow light is formed through secondary excitation, rather than primary excitation. The remaining blue light is then combined with the yellow and red light to form white light with color rendering exceeding 90.

In the white light light-emitting diode, the blue, yellow and red phosphor grains mixed in the phosphor layer with a proper ratio are excited by the ultraviolet light-emitting diode, achieving Commission Internationale de l'Eclairage (CIE) chromaticity coordinate of (0.33, 0.33), color temperature of 3000-8000K and color rendering exceeding 90.

### EXAMPLE 1

In accordance with the white light light-emitting diode shown in FIG. 1, blue phosphor grains had a weight percent of 35-40% in the total weight of phosphor grains. Yellow phosphor grains had a weight percent of 30-35% in the total weight of phosphor grains. Red phosphor grains had a weight percent of 25-35% in the total weight of phosphor grains. The white light light-emitting diode possessed improved luminescence performance, with color temperature of 6188K under 20 mA, color rendering of 93.69, and color coordinate of (0.33, 0.33).

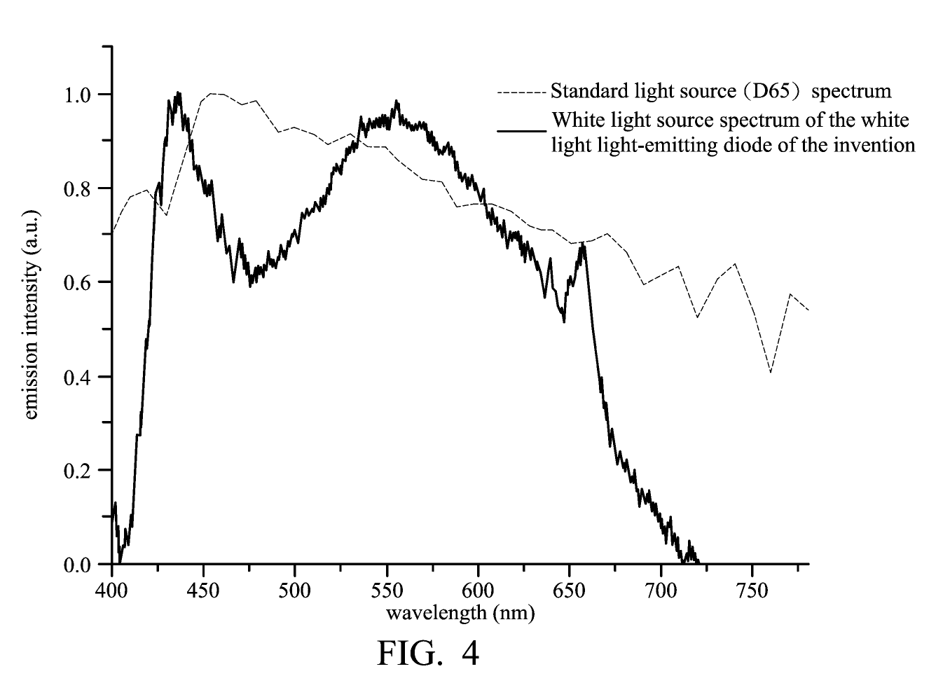

FIG. 4 shows spectrums of the abovementioned white light light-emitting diode and a CIE standard illuminates (D65) (CCT=6500K). In FIG. 4, the spectrum of the abovementioned white light light-emitting diode is similar to that of the CIE standard illuminates (D65). Thus, the quality of the the abovementioned white light light-emitting diode is similar to that of the standard light source (D65), achieving color coordinate (0.33, 0.33), color temperature less than 6500K and color rendering exceeding 90.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A white light light-emitting diode, comprising:
a substrate comprising an anode and a cathode or a circuit;
an ultraviolet light-emitting diode with a peak wavelength between 320-400 nm disposed on the substrate; and
a phosphor layer formed by blending blue, yellow and red phosphor grains with optically transparent resin, wherein the yellow phosphor grains are excited by blue light with a wavelength of 400-530 nm.

2. The white light light-emitting diode as claimed in claim 1, wherein the ultraviolet light-emitting diode comprises III-V photosemiconductor.

3. The white light light-emitting diode as claimed in claim 2, wherein the ultraviolet light-emitting diode comprises GaN, InGaAlN or AlGaN.

4. The white light light-emitting diode as claimed in claim 1, wherein the blue phosphor grains have a weight percent of 15-50% in a mixture of the blue, yellow and red phosphor grains.

5. The white light light-emitting diode as claimed in claim 1, wherein the yellow phosphor grains have a weight percent of 10-70% in a mixture of the blue, yellow and red phosphor grains.

6. The white light light-emitting diode as claimed in claim 1, wherein the red phosphor grains have a weight percent of 15-40% in a mixture of the blue, yellow and red phosphor grains.

7. The white light light-emitting diode as claimed in claim 1, wherein the optically transparent resin comprises epoxy or silicon resin.

8. A white light light-emitting diode, comprising:
a substrate comprising an anode and a cathode or a circuit;
an ultraviolet light-emitting diode emitting ultraviolet with a peak wavelength between 320-400 nm disposed on the substrate;
a transparent resin layer pervious to ultraviolet and visible light overlying the ultraviolet light-emitting diode; and
a phosphor layer formed by blending blue, yellow and red phosphor grains with transparent resin applied on the transparent resin layer, wherein the yellow phosphor grains are excited by an emitting blue light with an emission band between about 400-530 nm.

9. The white light light-emitting diode as claimed in claim 8, wherein the ultraviolet light-emitting diode comprises GaN, InGaAlN or AlGaN.

10. The white light light-emitting diode as claimed in claim 8, wherein the transparent resin layer comprises epoxy or silicon resin

11. The white light light-emitting diode as claimed in claim 8, wherein the blue phosphor grains have a weight percent of 15-50% in a mixture of the blue, yellow and red phosphor grains.

12. The white light light-emitting diode as claimed in claim 8, wherein the yellow phosphor grains have a weight percent of 10-70% in a mixture of the blue, yellow and red phosphor grains.

13. The white light light-emitting diode as claimed in claim 8, wherein the red phosphor grains have a weight percent of 15-40% in a mixture of the blue, yellow and red phosphor grains.

14. A white light light-emitting diode, comprising:
a substrate comprising an anode and a cathode or a circuit;
an ultraviolet light-emitting diode with a peak wavelength between 320-400 nm disposed on the substrate;
a transparent resin layer pervious to ultraviolet and visible light overlying the ultraviolet light-emitting diode; and
a plurality of phosphor layers comprising blue, yellow and red phosphor layers respectively formed by blending blue, yellow or red phosphor grains with transparent resin applied on the transparent resin layer, wherein the yellow phosphor grains are excited by an emitting blue light with an emission band between 400-530 nm.

15. The white light light-emitting diode as claimed in claim 14, wherein the ultraviolet light-emitting diode comprises GaN, InGaAlN or AlGaN.

16. The white light light-emitting diode as claimed in claim 14, wherein the blue phosphor grains have a weight percent of 5-40% in the blue phosphor layer.

17. The white light light-emitting diode as claimed in claim 14, wherein the yellow phosphor grains have a weight percent of 10-50% in the yellow phosphor layer.

18. The white light light-emitting diode as claimed in claim 14, wherein the red phosphor grains have a weight percent of 5-40% in the red phosphor layer.

19. The white light light-emitting diode as claimed in claim 14, wherein the transparent resin layer comprises epoxy or silicon resin.

20. The white light light-emitting diode as claimed in claim 14, wherein the blue, yellow and red phosphor layers are formed on the transparent resin layer in order.
